(19) United States
(12) Patent Application Publication
(10) Pub. No.: US 2012/0294539 A1
(43) Pub. Date: Nov. 22, 2012

(54) OBJECT IDENTIFICATION SYSTEM AND METHOD OF IDENTIFYING AN OBJECT USING THE SAME

(75) Inventors: Seong-Kyu Lim, Seoul (KR); Eui-Hyun Shin, Bucheon-si (KR)

(73) Assignee: KIWIPLE CO., LTD., Gangnam-gu, Seoul (KR)

(21) Appl. No.: 13/575,690

(22) PCT Filed: Jan. 28, 2011
(86) PCT No.: PCT/KR2011/000602

§ 371 Date: Jul. 27, 2012

(30) Foreign Application Priority Data
Jan. 29, 2010 (KR) 10-2010-0008551

(51) Int. Cl. G06K 9/62

(52) U.S. Cl. 382/218

(57) ABSTRACT

An object identification system includes a virtual object and an object identifying part. The virtual object storing part stores map data including an outline data of a virtual object. The object identifying part divides map data including outline data of virtual objects with a position previewing real objects as the central figure into a uniform angle gap with respect to an angle section corresponding to an image of the previewed real objects. The object identifying part extracts a virtual object having an outline firstly meet with a radiating line corresponding to each map angles of the divided map data from the map data. The object identifying part matches with the virtual object extracted from the map angle and a real object positioned at an azimuth angle equal to a map angle corresponding to the extracted virtual object.

### CROSS-REFERENCE TO RELATED APPLICATIONS

This application claims priority under 35 U.S.C. §119 to Korean Patent Application No. 10-2010-0008551, filed on Jan. 29, 2010 in the Korean Intellectual Property Office (KIPO), the contents of which are herein incorporated by reference in their entirety.

### BACKGROUND OF THE INVENTION

1. Technical Field

Exemplary embodiments of the present invention relate to an object identification system and a method of identifying an object using the system. More particularly, exemplary embodiments of the present invention relate to an object identification system for identifying an object in a more accurate and a method of identifying an object using the system.

2. Discussion of the Related Art

Recently, a concern for augmented reality technology has been increased, which identifies a real object such as a building through a camera of a mobile communication terminal (i.e., a mobile terminal) or displays information for a subject previewed through the camera on a screen of the mobile terminal in a virtual.

As an augmented reality technology is performed in based on a point of interest (POI) representing a building not a building itself, a real object viewed by a person and virtual information are not matched with each other. For example, when two buildings are side by side, a rear building is blocked by a front building so that the rear building is not seen in an actual. However, since virtual information related to the rear building is displayed on a preview image, a peripheral region is simply displayed on the preview image so that it is not a substantial augmented reality service.

Thus, it is needed that an object identification system and an object identification method which capable of displaying virtual information matched with a real object viewed by person in an actual on a preview image.

### SUMMARY

Exemplary embodiments of the present invention provide an object identification system for identifying an object previewed on a screen in a more accurate and preventing from outputting of attribute value no related to the previewed object.

Exemplary embodiments of the present invention also provide a method of identifying an object which capable of identifying an object previewed on a screen in a more accurate and preventing from outputting of attribute value no related to the previewed object.

According to one aspect of the present invention, an object identification system includes a virtual object and an object identifying part. The virtual object storing part is configured to store map data including an outline data of a virtual object. The object identifying part is configured to divide map data including outline data of virtual objects with a position previewing real objects as the central figure into a uniform angle gap with respect to an angle section corresponding to an image of the previewed real objects. The object identifying part is configured to extract a virtual object having an outline firstly meet with a radiating line corresponding to each map angles of the divided map data from the map data. The object identifying part is configured to match with the virtual object extracted from the map angle and a real object positioned at an azimuth angle substantially equal to a map angle corresponding to the extracted virtual object.

In an exemplary embodiment, the virtual object storing part may further store a position value of a point of interest. The object identifying part may match a point of interest positioned at an area surrounded by an outline of the virtual object with a virtual object having an outline surrounding the point of interest.

In an exemplary embodiment, the virtual object storing part may further store an attribute value of the point of interest. The object identification system may output the attribute value of a point of interest positioned at an area surrounded by an outline of the virtual object extracted by the object identifying part to an image of the previewed real object.

In an exemplary embodiment, the virtual object storing part may further store an attribute value of a virtual object. The object identification system may output the attribute value of the virtual object extracted by the object identifying part to an image of the previewed real object.

In an exemplary embodiment, the outline data of the map data may include position values of corners of each of the virtual objects, and an outline of each of the virtual object on the map data may be a straight line connecting positions of neighboring corners of each of the virtual objects.

In an exemplary embodiment, the virtual object storing part and the object identifying part may be equipped to a server computer. In this case, the virtual object storing part may further store an attribute value of a virtual object. The server computer may receive a position value of the mobile terminal corresponding to a position previewing the real object and an azimuth value of a direction previewing a real object from the mobile terminal, and may transmit an attribute value of a virtual object matched with the previewed real object to the mobile terminal.

In an exemplary embodiment, the object identification system may be a mobile terminal including the virtual object storing part and the object identifying part.

According to another aspect of the present invention, there is provided a method of identifying an object. In the method, map data including outline data of virtual objects with a position previewing real objects as the central figure is divided into a uniform angle gap with respect to an angle section corresponding to an image of the previewed real objects, and a virtual object is extracted from the map data, which has an outline firstly meet with a radiating line corresponding to each map angles of the divided map data. Then, the virtual object extracted from the map angle is matching with a real object positioned at an azimuth angle substantially equal to a map angle corresponding to the extracted virtual object.

In an exemplary embodiment, an attribute value of a virtual object matched with the previewed real object may be further outputted to an image of the previewed real object.

In an exemplary embodiment, a point of interest positioned at an area surrounded by an outline of a virtual object may be matched with a virtual object having an outline surrounding the point of interest. An attribute value of a virtual object outputted to an image of the previewed image may be an attribute value of a point of interest positioned at an area surrounded by an outline of the extracted virtual object.

In an exemplary embodiment, the present may be a computer-readable storage medium storing a software program using the above mentioned object identification method.

According to one aspect of the present invention, an object identification system is configured to divide map data including outline data of virtual objects with a position previewing real objects as the central figure into a uniform angle gap with respect to an angle section corresponding to an image of the previewed real objects, to extract a virtual object having an outline firstly meet with a radiating line corresponding to each map angles of the divided map data from the map data, and to match with the virtual object extracted from the map angle and a real object positioned at an azimuth angle substantially equal to a map angle corresponding to the extracted virtual object.

In an exemplary embodiment, an attribute value of a point of interest positioned at an area surrounded by an outline of the virtual object extracted by the object identifying part may be outputted to an image of the previewed real object.

In an exemplary embodiment, the present invention may be a server computer identifying a virtual object matched with the previewed real object and transmitting an attribute value of the identified virtual object to a mobile terminal by using the above-mentioned object identification system.

In an exemplary embodiment, the present invention may be a mobile terminal outputting an attribute value of a virtual object matched with the previewed real object by using the above-mentioned object identification system.

According to an object identification system and a method of identifying an object using the system, an attribute value related to a real object not shown on a previewed image is not outputted, and an attribute value shown on the previewed image is only outputted.

Thus, it may prevent an error of an object identifying and it may identify a real object in a more accurate, thereby improving a quality of an object identification system or an augmented reality service.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a plan view showing a display screen for explaining a method of identifying an object in accordance with an exemplary embodiment of the present invention;

FIG. 2 is a plan view showing map data used in an object identification method according to an exemplary embodiment of the present invention;

FIG. 3 is a plan view showing that a point of interest (POI) is displayed on the map data of FIG. 2 in accordance with an exemplary embodiment of the present invention;

FIG. 4 is a plan view showing that an interest point attribute value of a virtual object matched with a previewed real object is outputted to a preview image in accordance with a comparative embodiment;

FIG. 5 is a plan view showing that an interest point attribute value of a virtual object matched with a previewed real object is outputted to a preview image in accordance with an exemplary embodiment of the present invention;

FIG. 6 is a block diagram showing an object identification system according to another exemplary embodiment of the present invention; and

FIG. 7 is a block diagram showing an object identification system according to another exemplary embodiment of the present invention.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

Hereinafter, terms used in the present specification will be defined.

A term “preview” means that a user views an object or a target through a screen of a mobile terminal or an image displayed on a display screen in a real time.

A term “object” means all matters or all events capable of being identified by a user. For example, the term “object” is used as a concept including a matter such as buildings or trees of which positions are fixed, a place of a predetermined position, a matter such as vehicles of which a moving path is regular, a nature matter such as the sun, the moon and the star of which a moving path according to a time is regular, industrial products having a unique number or unique mark, designs such a predetermined text, mark, trademark, person, an event or culture performances generated at a predetermined time, etc. In the present disclosure, the term “object” mainly means a matter such as buildings or trees of which positions are fixed, a place of a predetermined position.

A term “attribute” means whole information related to an object, which means information stored in a computer-readable storage medium such as a memory, a disk, etc., as a database.

The object is classified into “a real object” called as a target existed in a real world and “a virtual object” which is stored and processed by the object identification system in accordance with the real object. The virtual object corresponds to a virtual world object storing characteristics such as a position, an address, a shape, a name, a related information, a related web page address, etc., of a corresponding real object as a database. Moreover, “an attribute of a virtual object” means information such as a position, an address, a shape, a name, related information, a related web page address, etc., of a corresponding real object stored in a computer-readable storage medium as a database. The attribute of a virtual object may include an established year of building or sculpture, history of building or sculpture, use of building or sculpture, an age of tree, a kind of tree, etc.

A term “a real object is matched with a virtual object” or a term “matching a real object with a virtual object” means that the attribute of a real object and the attribute of a virtual object are the same as each other or the attribute of a real object corresponds with or relates to a virtual object having the same attribute within an error range. For example, a term “a previewed real object (e.g., a real building) matches with a virtual object of map data (i.e., a building on a map)” means that the previewed building (i.e., a real object) corresponds with a building (i.e., a virtual object) having the same attribute (e.g., a position or a name) on a map, or the previewed building corresponds with a building on the map in a one-to-one correspondence.

A term “object identification” means that it is to extract a virtual object matched with the previewed real object in a real time.

A term “augmented reality” means a virtual reality that a real world viewed through eyes of a user and a virtual world having additional information are added to be displayed on image.

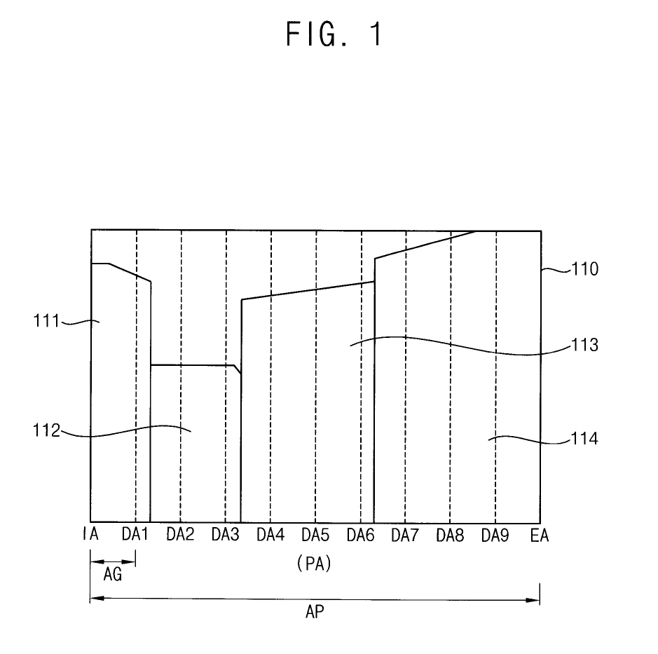

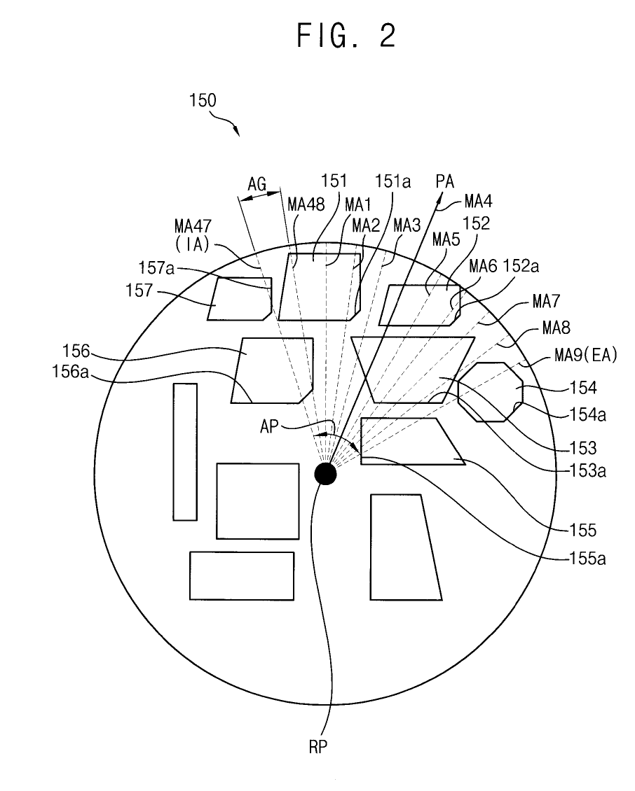

FIG. 1 is a plan view showing a display screen for explaining a method of identifying an object in accordance with an exemplary embodiment of the present invention. FIG. 2 is a plan view showing map data used in an object identification method according to an exemplary embodiment of the present invention.

Referring to FIGS. 1 and 2, an object identification method according to the present exemplary embodiment includes a step of dividing map data 150 including outline data of virtual objects 151, 152, 153, 154, 155, 156 and 157 with a position RP previewing real objects 111, 112, 113 and 114 as the central figure into a uniform angle gap AP with respect to an angle section AP corresponding to an image of the previewed real objects 111, 112, 113 and 114, and extracting a virtual object from the map data 150, which has an outline firstly meet with a radiating line corresponding to each map angles MA1 to MA48 of the divided map data 150.

As defined above, a term “object” means all matters capable of being identified by a user. For example, the term “object” means a matter such as buildings or trees, bronze statue of which positions are fixed. Particularly, a term “real object” means an object in a real world, for example, a real matter or a real sculpture such as a real build, a real tree, a real bronze statue, etc.

Moreover, a term “preview” means an action viewing the object or target through a display screen. For example, when a user previews the real object (e.g., a building, a sculpture, treed, etc.) through a mobile terminal including an image identifying part such as a camera and a display screen displaying an image provided by the image identifying part, an image of the real object is converted by the image identifying part and the image is displayed on the display. As an example, the mobile terminal including the image identifying part and the display screen may be a portable telephone, a smart phone, a personal digital assistance (“PDA”), a digital video camera, etc.

The real objects 111, 112, 113 and 114 includes a first real object 111, a second real object 112, a third real object 113 and a fourth real object 114. It is assumed that the real objects 111, 112, 113 and 114 previewed on a display screen 110 shown in FIG. 1 are buildings. However, the present is not limited to that a real object is a building. That is, it may be adapted that a sculpture such as a building, a tower, etc., of which positions are fixed or a natural matter such as a tree, a rock, etc., of which positions are fixed is a real object.

A position RP previewing the real objects 111, 112, 113 and 114 corresponds to a position of a mobile terminal including a display screen 110 in a real space.

The position RP previewing the real objects 111, 112, 113 and 114, that is, a position value of a mobile terminal may be generated by a mobile terminal having global positioning system (GPS) receiver capable of communicating with a GPS satellite. Alternatively, the position value of the mobile terminal may be generated by measuring a distance between the mobile terminal and a base station such as a wireless local area network access point (WLAN AP) or a distance between the mobile terminal and a repeater.

The map data 150 includes data related to positions of plural virtual objects and shapes of plural virtual objects. In this case, the virtual object means an object of a virtual world corresponding to a real object. For example, the virtual object may correspond with a virtual object such as a virtual building, a virtual bronze statue, a virtual sculpture, a virtual nature matter, etc. In the present exemplary embodiment, the virtual object includes first to seventh virtual objects 151, 152, 153, 154, 155, 156 and 157. Each of the first to seventh virtual objects 151, 152, 153, 154, 155, 156 and 157 may have first to seventh outlines 151a, 152a, 153a, 154a, 155a, 156a and 157a, respectively. That is, the map data 150 have an outline data as an attribute.

In the present exemplary embodiment, the outline data means data for representing an outline shape of a virtual object on a map. The outline data may be data related to a two-dimensional shape of a virtual object. Alternatively, the outline data may be data related to a three-dimensional shape.

For example, when the outline data is data for representing a plan shape of a virtual object, the outline data may include position values of corners of the virtual objects. In this case, a straight line connecting positions of neighboring corners of each of the virtual objects is drawn on the map data 150 by using position values of corners of the virtual object, so that outlines of each of the virtual objects may be drawn on the map data 150.

Alternatively, the outline data may include a position value of the virtual object and relative position values between corners of the virtual object and the position value of the virtual object. For example, the outline data may include a relative position value such as a distance between the corner position and the virtual object position and a direction instead of absolute values of the corners. In this case, positions of each corners of the object may be calculated by a position value of the virtual object and relative position values of the corners. When a straight line connecting adjacent corner positions of each of the virtual objects is drawing on the map data 150, an outline of each of the virtual objects may be drawn on the map data 150.

An angle gap AP corresponding to an image of the previewed real objects 111, 112, 113 and 114 means a range from an azimuth angle corresponding to a left edge portion of a display screen 110 to an azimuth angle corresponding to right edge portion of the display screen 110 when an indicator space is defined as azimuth angle of 0 degrees to 360 degrees with respect to a predetermined direction (e.g., due north direction).

The azimuth angle corresponding to the left edge portion of the display screen 110 and the azimuth angle corresponding to the right edge portion of the display screen 110 may be measured by a direction sensor or a compass of a mobile terminal. For example, when a mobile terminal includes a direction sensor, an azimuth angle PA of a direction previewing the real objects 111, 112, 113 and 114 corresponding to a center of the display screen 110 may be measured by the direction sensor.

Moreover, a viewing angle (i.e., a difference between an azimuth angle corresponding to the left edge portion of the display screen 110 and an azimuth angle corresponding to the right edge portion of the display screen 110) of the display screen 110 may have a range between about 40 degrees to about 80 degrees in accordance with a scale of the previewed image. A viewing angle of the display screen 110 may be varied in accordance with a kind of the display screen 110 of the mobile terminal or a scale of the previewed image. However, a viewing angle for the previewed image having a predetermined scale may be set by the mobile terminal previewing the image. A viewing angle of the display screen 110 may be transmitted to an object identification system or a server computer employing an object identification method according to the present invention. That is, the viewing angle of the display screen 110 is not measured to have a predetermined set value in accordance with the display screen 110 and a scale of the previewed image.

An initial azimuth angle IA of an angle section AP and an end azimuth angle EA corresponding to an image of the previewed real objects 111, 112, 113 and 114 may be set from an azimuth angle PA of a previewing direction that is measured and a viewing angle of the display screen 110.

In this exemplary embodiment shown in FIGS. 1 and 2, it is assumed that an azimuth angle PA of the previewing position RP is about 22.5 degrees and a viewing angle of the display screen 110 is about 75 degrees. In this case, an initial azimuth angle IA of an angle section AP corresponding to an image of the previewed real object is about 345 degrees (or about −5 degrees), and an end azimuth angle EA of an angle section AP is about 60 degrees. An invention related to a method of measuring an azimuth angle of a previewing direction in a case of non-existing a direction sensor and an object identification method using the method is disclosed in Korean Patent Application No. 10-2010-0002711.

When an angle section AP corresponding to an image of the previewed real objects 111, 112, 113 and 114 is set by using the above method, as shown in FIG. 2, the map data 150 is divided into uniform angle gaps AG with respect to an angle section AP corresponding to an image of the previewed real object with a previewing position RP as the central figure.

When the angle gap AG is X degrees, a virtual space of the map data 150 is divided into 360/X spaces with respect to the previewing position RP. For example, when the angle gap AG is about 7.5 degrees, a virtual space of the map data 150 is divided into forty-eight equal parts (i.e., 360/7.5=48) with respect to the previewing position RP. In this case, it is assumed that each angles divided into forty-eight equal parts of the map data 150 with respect to due north on map data 150 are first to forty-eighth map angles MA1 to MA48.

Since an initial azimuth angle IA of an angle section AP corresponding to an image of a real object previewed on the display screen 110 shown in FIG. 1 is about 345 degrees (or about −15 degrees) and an end azimuth angle EA of the angle section AP is about 60 degrees, an angel section AP corresponding to an image of the previewed real object correspond with from forty-seventeenth map angle MA47 to ninth map angle MA9 in the map data 150.

In this case, virtual radiating lines (shown as a dot line in FIG. 2) are assumed, which correspond with each map angles MA47, MA48, MA1 to MA9 of the map data divided into uniform angle gap AG for the angle section AP with respect to a previewing position RP. That is, in the map data 150 shown in FIG. 2, the virtual radiating lines are extended per each of the map angle MA47, MA48, MA1 to MA9.

According to the present invention, a virtual object is extracted, which has an outline firstly meet with a radiating line corresponding to each of the map angles MA47, MA48, MA1 to MA9 from the map data 150.

For example, in the map data 150 shown in FIG. 2, a virtual object having an outline 151a firstly meet with a radiating line corresponding to the first map angle MA1 is a first virtual object 151. A virtual object which has an outline 151a firstly meet with a radiating line corresponding to the second map angle MA2 is also the first virtual object 151. That is, a virtual object extracted from the first map angle MA1 and the second map angle MA2 is the first virtual object 151.

A virtual object which has an outline 153a firstly meets with a radiating line corresponding to the third map angle MA3 is a third virtual object 153. It is determined that a radiating line corresponding to the third map angle MA3 is met with an outline 152a of a second virtual object 152 and is not firstly met with an outline 152a of the second virtual object 152. Thus, a virtual object extracted from a third map angle MA3 is a third virtual object 153 which has an outline 153a firstly meets with a radiating line corresponding to the third map angle MA3. Similarly, since a virtual object having an outline 153a firstly meets with radiating lines corresponding to a fourth map angle MA4 and a fifth map angle MA5 is also the third virtual object 153, a virtual object extracted from a fourth map angle MA4 and a fifth map angle MA5 is the third virtual object 153.

A virtual object which has an outline 155a firstly meets with a radiating line corresponding to the sixth map angle MA6 is a fifth virtual object 155. It is determined that a radiating line corresponding to the sixth map angle MA6 is met with an outline 152a of a second virtual object 152 and an outline 153a of a third virtual object 153 and is not firstly met with an outline 152a of the second virtual object 152 and an outline 153a of the third virtual object 153. Thus, a virtual object extracted from a sixth map angle MA6 is a fifth virtual object 155 which has an outline 155a firstly meets with a radiating line corresponding to the sixth map angle MA6. Similarly, since a virtual object having an outline 155a firstly meets with radiating lines corresponding to a seventh map angle MA7 to ninth map angle MA9 is also the fifth virtual object 155, a virtual object extracted from the seventh map angle MA7 to the ninth map angle MA9 is the fifth virtual object 155.

A virtual object which has an outline 156a firstly meets with a radiating line corresponding to the forty-seventh map angle MA47 is a sixth virtual object 156. It is determined that a radiating line corresponding to the forty-seventh map angle MA47 is met with an outline 157a of the seventh virtual object 157 and is not firstly met with an outline 157a of the seventh virtual object 157. Thus, a virtual object extracted from the forty-seventh map angle MA47 is a sixth object 157 which has the outline 156a firstly meets with a radiating line corresponding to the forty-seventh map angle MA47. Similarly, since a virtual object having an outline 156a firstly meets with radiating lines corresponding to a forty-eighth map angle MA48 is also a sixth virtual object 156, a virtual object extracted from the forty-eighth map angle MA48 is the sixth virtual object 156.

Accordingly, virtual objects extracted from the map data based on an image of the previewed real objects 111, 112, 113 and 114 are a first virtual object 151, a third virtual object 153, a fifth virtual object 155 and a sixth virtual object 156, respectively.

An object identification method according to the present invention may include a step of matching virtual objects 151, 153, 155 and 156 extracted from the map angle into a real object positioned at an azimuth angle substantially equal to a map angle corresponding to the extracted virtual objects 151, 153, 155 and 156.

For example, an angle section AP corresponding to an image of a real object previewed through the display screen 110 is divided into angle gaps AG substantially equal to each other. The angle gap AG shown in FIG. 1 may be substantially equal to the angle gap AG shown in FIG. 2.

In the present exemplary embodiment, a size of the angle section AP is about 75 degrees and the angle gap AG is about 7.5 degrees, so that the angle section AP is divided into ten equal parts. Moreover, an initial azimuth angle IA of the angle section AP is about 345 degrees (about −15 degrees) and an end azimuth angle EA of the angle section AP is about 60 degrees, so that a first azimuth angle DA1, a second azimuth angle DA2, a third azimuth angle DA3, a fourth azimuth angle DA4, a fifth azimuth angle DA5, a sixth azimuth angle DA6, a seventh azimuth angle DA7, an eighth azimuth angle DA8 and a ninth azimuth angle DA9 are about 352.5 degrees (about −7.5 degrees), about 0 degrees, about 7.5 degrees, about 15 degrees, about 22.5 degrees, about 30 degrees, about 37.5 degrees, about 45 degrees and about 52.5 degrees, respectively.

The about 345 degrees (or about −15 degrees) that is an initial azimuth angle IA shown in FIG. 1 corresponds with a forty-seventeenth map angle MA47 that is an initial azimuth angle IA of the map data 150 shown in FIG. 2, and the about 60 degrees that is an end azimuth angle EA shown in FIG. 1 corresponds with a ninth map angle MA9 that is an end azimuth angle EA of the map data 150 shown in FIG. 2. Thus, a first azimuth angle DA1 corresponds with a forty-eighth map angle MA48 of the map data 150. A second azimuth angle DA2 and a third azimuth angle DA3 correspond with a first map angle MA1 and a second map angle MA2 of the map data 150, respectively. A fourth azimuth angle DA4, a fifth azimuth angle DA5 and a sixth azimuth angle DA6 correspond with a third map angle MA3, a fourth map angle MA4 and a sixth map angle MA6 of the map data 150, respectively. A seventh azimuth angle DA7, an eighth azimuth angle DA8 and a ninth azimuth angle DA9 correspond with a sixth map angle MA6, a seventh map angle MA7 and an eighth map angle MA8 of the map data 150, respectively.

As described above, virtual objects extracted from the map data based in an image of the previewed real objects 111, 112, 113 and 114 are a first virtual object 151, a second virtual object 153, a fifth virtual object 155 and a sixth virtual object 156.

In this case, map angles corresponding to the extracted first virtual object 151 are a first map angle MA1 and a second map angle MA2, and azimuth angles substantially equal to the first map angle MA1 and the second map angle MA2 are the second azimuth angle DA2 and the third azimuth angle DA3 of FIG. 1, respectively. In FIG. 1, it is determined that a real object positioned at the second azimuth angle DA2 and the third azimuth angle DA3 is a second real object 112. That is, a real object positioned at azimuth angles DA2 and DA3 substantially equal to the map angles MA1 and MA2 corresponding to the extracted first virtual object 151 is a second real object 112. Thus, it may match a first virtual object 151 extracted from the map angles MA1 and MA2 into the second real object 112 positioned at azimuth angles DA2 and DA3 substantially equal to the map angles MA1 and MA2 corresponding to the extracted first virtual object 151.

Moreover, map angles corresponding to the extracted third virtual object 153 are a third map angle MA3, a fourth map angle MA4 and a fifth map angle MA5, and azimuth angles substantially equal to the third map angle MA3, the fourth map angle MA4 and the fifth map angle MA5 are the fourth azimuth angle DA4, the fifth azimuth angle MA5 and the sixth azimuth angle DA6 of FIG. 1, respectively. In FIG. 1, it is determined that a real object positioned at the fourth azimuth angle DA4, the fifth azimuth angle MA5 and the sixth azimuth angle DA6 is a third real object 113. That is, a real object positioned at azimuth angles DA4, DA5 and DA6 substantially equal to the map angles MA3, MA4 and MA5 corresponding to the extracted third virtual object 153 is a third real object 113. Thus, it may match a third virtual object 153 extracted from the map angles MA3, MA4 and MA5 into the third real object 113 positioned at azimuth angles DA4, DA5 and DA6 substantially equal to the map angles MA3, MA4 and MA5 corresponding to the extracted second virtual object 152.

Similarly, it may match a fifth virtual object 155 extracted from the map angles MA6, MA7, MA8 and MA9 into a fourth real object 114 positioned at azimuth angles DA7, DA8, DA9 and EA substantially equal to the map angles MA6, MA7, MA8 and MA9 corresponding to the extracted fifth virtual object 155. Moreover, it may match a sixth virtual object 156 extracted from the map angles MA47 and MA48 into a first real object 111 positioned at azimuth angles IA and DA1 substantially equal to the map angles MA47 and MA48 corresponding to the extracted sixth virtual object 156.

Accordingly, it may match virtual objects 151, 153, 155 and 156 extracted from the map angles into real objects 112, 113, 114 and 111 positioned at azimuth angles substantially equal to the map angles corresponding to the extracted virtual objects 151, 153, 155 and 156, respectively.

The virtual objects 151 to 157 may have attribute values respectively related to the virtual objects. The attribute of a virtual object means information such as a position value, an address, a shape, a height, a name, a related web page address, an established year of building or sculpture, history of building or sculpture, use of building or sculpture, an age of tree, a kind of tree, etc., storable in a computer-readable storage medium as a database.

An object identification method according to the present invention may further include a step of outputting an attribute value of a virtual object matched with the previewed real object into the previewed image. That is, when the extracted virtual objects 151, 153, 155 and 156 are matched with the previewed real objects 112, 113, 114 and 111, respectively, attribute values of the extracted virtual objects 151, 153, 155 and 156 may be outputted to the previewed image.

Example, when it is assumed that a third virtual object 153 has a name called “Kiwiple Building” as an attribute value, the extracted third virtual object 153 is matched with the previewed third real object 113 in the present embodiment. Thus, “Kiwiple Building” that is an attribute value of the third virtual object 153 may be outputted to an image of the previewed third real object 113.

In an exemplary embodiment, when an attribute value of the third virtual object 153 is a web page address, even though the web page address is not inputted through a mobile terminal, it may access to a web page related to the third real object 113 in a state that the third real object 113 matched with the third virtual object 153 is previewed.

Each of the virtual objects 151 to 157 may include a position value of a point of interest and an interest point attribute value. The point of interest means a position of a specific virtual object capable of inducing an interest of users of map data such as a specific building, a store, etc., besides a simple road or a simple topography displayed on map data. The point of interest is called as an abbreviation “POI.” The point of interest may be set by a service provider providing map data in advance. Alternatively, the point of interest may be set by a user using the map data in addition.

A position value of the point of interest may include a latitude value and a longitude value stored in the map data. The interest point attribute value means information related to the point of interest storable in a computer-readable storage medium as a database, such as names, addresses, shapes and heights of the point of interest, advertisement related to the point of interest, a web page address related to the point of interest, an established year, history, use, kinds, etc., of building or sculpture. The position value of the point of interest and the interest point attribute value correspond with a kind of attribute value of the virtual object.

When the virtual object includes an interest point attribute value as an attribute value, an interest point attribute value of the extracted virtual object may be outputted to the previewed image.

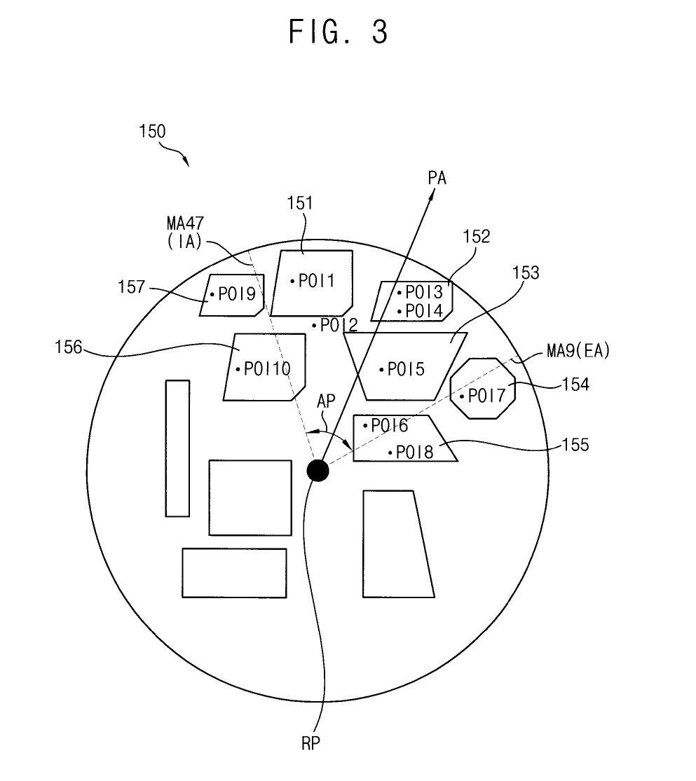

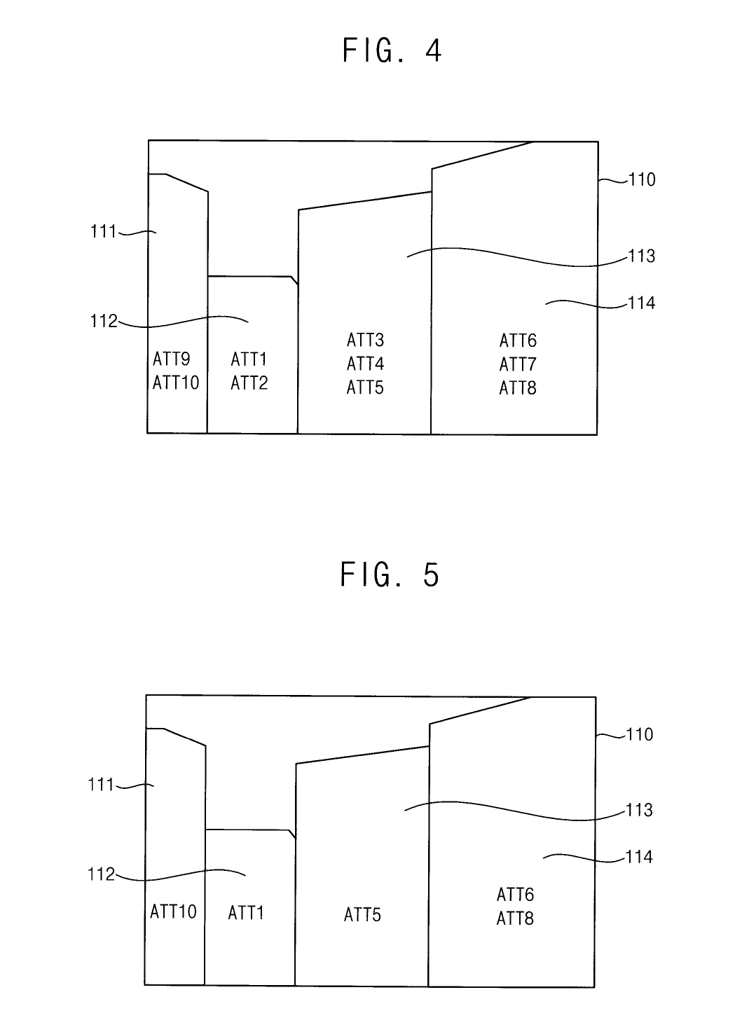

FIG. 3 is a plan view showing that a point of interest is displayed on the map data of FIG. 2 in accordance with an exemplary embodiment of the present invention. FIG. 4 is a plan view showing that an interest point attribute value of a virtual object matched with a previewed real object is outputted to a preview image in accordance with a comparative embodiment. FIG. 5 is a plan view showing that an interest point attribute value of a virtual object matched with a previewed real object is outputted to a preview image in accordance with an exemplary embodiment of the present invention

Referring to FIGS. 3 to 5, the map data 150 includes first to tenth points of interest POI1 to POI10. In FIG. 3, ten points of interest are displayed; however, it is not limited to the number of points of interest.

A first point of interest POI1 includes a position value of the first point of interest POI1 and a first interest point attribute value ATT1. A second point of interest POI2 includes a position value of the second point of interest POI2 and a second interest point attribute value ATT2. Similarly, each of third to tenth points of interest POI3 to POI10 includes position values of the third to tenth points of interest POI3 to POI10 and third to tenth interest point attribute values ATT3 to ATT10, respectively.

Each of position values of the first to tenth points of interest POI1 to POI10 may include latitude values and longitude values of the first to tenth points of interest POI1 to POI10 stored in the map data 150. Moreover, each of the first to tenth interest point attribute values ATT1 to ATT10 may include information such as names, addresses, shapes and heights of points of interest POI1 to POI10, trademarks of points of interest POI1 to POI10 and related web page address of points of interest POI1 to POI10, which capable of being stored in a computer-readable storage medium.

An object identification method according to the present invention may include a step of matching with a point of interest position at an area surrounded by an outline of a virtual object and a virtual object having an outline surrounding the point of interest.

For example, since a position of a first point of interest POI1 is surrounded by an outline of a first virtual object 151, the first point of interest POI1 corresponds with the first virtual object 151. A virtual object having an outline surrounding a second point of interest POI2 does not exist in FIG. 3. Thus, the second point of interest POI2 does not correspond with any virtual object.

Since a third point of interest POI3 and a fourth point of interest POI4 are surrounded by an outline of a second virtual object 152, the third and fourth points of interest POI3 and POI4 is correspond to the second virtual object 152. Similarly, the fifth point of interest POI5 is correspond to the third virtual object 153, and the seventh point of interest POI7 is correspond to the fourth virtual object 154. The sixth point of interest POI6 and the eighth point of interest POI8 are correspond to the fifth virtual object 155. The ninth point of interest POI9 is correspond to the seventh virtual object 157, and the tenth point of interest POI10 is correspond to the sixth virtual object 156.

As described refer to FIGS. 1 and 2, according to the present invention, a virtual object is extracted from the map data 150, which has an outline firstly meet with a radiating line respectively corresponding to each map angles of the map data 150 divided into uniform angle gap AG with respect to an angle section AP corresponding to an image of the previewed real object.

When a virtual object extracting method according to the present invention is not adapted thereto, as described in a comparative embodiment of FIG. 4, interest point attribute values ATT1 to ATT10 of all point of interest POI1 to POI10 existed in an angle gap AP corresponding to the previewed image are displayed on the previewed image. For example, in an azimuth angle PA of a previewing direction, a third real object 113 is shown on the previewed image of the display screen 110, and a real object corresponding to a second virtual object 152 is blocked by the third real object 113 so that a real object corresponding to a second virtual object 152 is not shown on the previewed image of the display screen 110. Nevertheless, a third interest point attribute value ATT3 and a fourth interest point attribute value ATT4 of a second virtual object 152 besides a fifth interest point attribute value ATT5 of the third virtual object 153 are outputted to an image previewed on the display screen 110. In this case, the third interest point attribute value ATT3 and the fourth interest point attribute value ATT4 of the second virtual object 152 which is no related to the third real object 113 may be misunderstood as an information related to the third real object 113. That is, it is not recognized that the third real object 113 is matched with the third virtual object 153 in a more accurate.

However, according to the present invention as described reference to FIGS. 1 and 2, a third virtual object 153 which has an outline firstly meet with a radiating line corresponding to an azimuth angle PA of the previewing direction is extracted prior to outputting an attribute value (e.g., an interest point attribute value) to an image previewed on the display screen 110, and then the extracted third virtual object 153 is matched with the third real object 113. Thus, as shown in FIG. 5, a fifth interest point attribute value ATT5 of a third virtual object 153 matched with the third real object 113 is only outputted to the image previewed on the display screen 110. It is noted that a third interest point attribute value ATT3 and a fourth interest point attribute value ATT4 are not outputted, which are related to a real object blocked by the third real object 113 to be not displayed on an image previewed on the display screen 110. That is, according to the present invention, it may visually identify that an information related to the third real object 113 is the fifth interest point attribute value ATT5 of the third virtual object 153 not the third interest point attribute value ATT3 and the fourth interest point attribute value ATT4 of the second virtual object 152.

Moreover, even though a real object corresponding to a seventh virtual object 157 is blocked by a first real object 111 so that the real object corresponding to the seventh virtual object 157 is not shown on the previewed image of the display screen 110. Nevertheless, according to a comparative embodiment, a ninth interest point attribute value ATT9 of a seventh virtual object 117 besides a tenth interest point attribute value ATT10 of a sixth virtual object 156 matched with the first real object 111 are outputted to an image previewed on the display screen 110. In this case, the tenth interest point attribute value ATT10 of the sixth virtual object 156 which is no related to the first real object 111 may be misunderstood as an information related to the third real object 113. However, according to the present invention, as described with reference to FIG. 5, the tenth interest point attribute value ATT10 of the sixth virtual object 156 matched with the first real object 111 is only outputted to an image previewed on the display screen 110. Thus, it may visually identify that an information related to the first real object 111 is the tenth interest point attribute value ATT10 of the sixth virtual object 156 not the ninth interest point attribute value ATT9 of the seventh virtual object 157.

In a comparative embodiment of FIG. 4, a second interest point attribute value ATT2 which does not belong to any virtual object besides a first interest point attribute value ATT1 of a first virtual object 151 matched with the second real object 112 are outputted to an image previewed on the display screen 110. In this case, the second interest point attribute value ATT2 which is no related to the second real object 112 may be misunderstood as information related to the second real object 112. However, according to the present invention, as described with reference to FIG. 5, the first interest point attribute value ATT1 of the first virtual object 151 matched with the second real object 112 is only outputted to an image previewed on the display screen 110.

Similarly, in a comparative embodiment of FIG. 4, a ninth interest point attribute value ATT9 of a fourth virtual object 154 besides a sixth interest point attribute value ATT6 and an eighth interest point attribute value ATT8 of a fifth virtual object 155 matched with the fourth real object 114 are outputted to an image previewed on the display screen 110. However, according to the present invention, as described with reference to FIG. 5, since the sixth interest point attribute value ATT6 and the eighth interest point attribute value ATT8 of the fifth virtual object 155 matched with the fourth real object 114 are only outputted to an image previewed on the display screen 110, it may visually identify that an information related to the fourth real object 114 is the sixth interest point attribute value ATT6 and the eighth interest point attribute value ATT8 of the fifth virtual object 155.

In an exemplary embodiment, an object identification method according to the present invention is produced as software used in a digital device such as an object identification system, a wireless Internet system, a server computer providing an object identification service or an augmented reality service, a portable telephone, a smart phone, a PDA, etc., to be stored in a computer-readable storage medium.

For example, an objection identification method according to the present invention may be used in a program for identifying an object used in a mobile terminal such as a portable telephone, a smart phone, a PDA, etc., and an application program such as an augmented reality executing program, a wireless Internet browser, etc. The application program using the objection identification method may be stored in a computer-readable storage medium such as memory embedded in a mobile terminal such as a portable telephone, a smart phone, a PDA, etc. That is, a claim scope of objection identification method according to the present invention may include a computer-readable storage medium storing an application program of a digital device such as the mobile terminal.

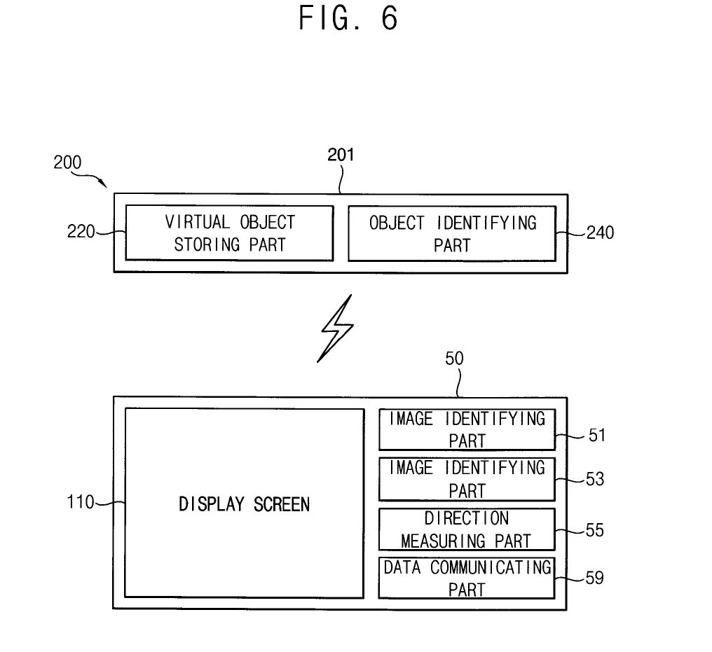

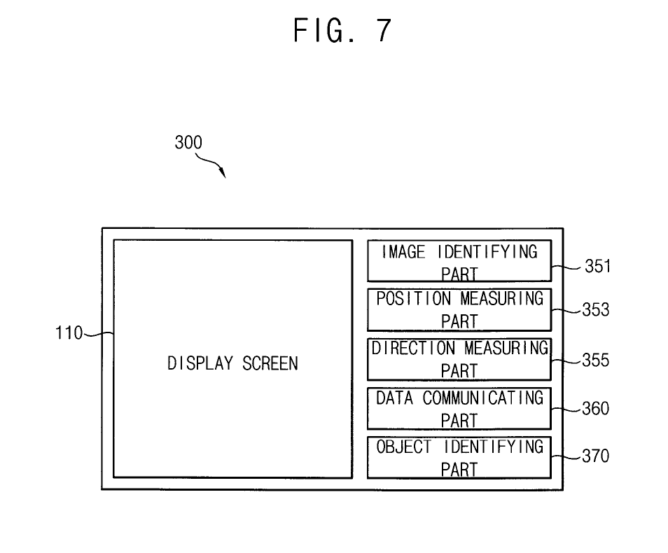

Moreover, an object identification method according to the present invention may be realized by using an object identification system which will be explained with reference to FIGS. 6 and 7.

According to the present invention, map data is divided into a angle gap which is uniform with respect to an angle section corresponding to an image of a previewed real object, and a virtual object which has an outline firstly meet with a radiating line corresponding to each of the map angle of the divided map data is extracted from the map data to match the extracted virtual object with the previewed real object, so that an attribute value related to a real object not shown on a previewed image is not outputted, and an attribute value shown on the previewed image is only outputted. Thus, it may prevent an error of an object identifying and it may identify a real object in a more accurate, thereby improving a quality of an object identification system or an augmented reality service.

FIG. 6 is a block diagram showing an object identification system according to another exemplary embodiment of the present invention.

Referring to FIG. 6, an object identification system 200 according to an exemplary embodiment of the present invention includes a virtual object storing part 220 and an object identifying part 240.

The virtual object storing part 220 stores map data (reference numeral 150 in FIG. 2) including an outline data of a virtual object.

As described refer to FIGS. 2 and 3, the map data 150 includes data related to positions of plural virtual objects and shapes of plural virtual objects. In this case, the virtual object refers to an object of a virtual world corresponding to a real object. For example, the virtual object may correspond with a virtual object such as a virtual building, a virtual bronze statue, a virtual sculpture, a virtual nature matter, etc.

The outline data means data for representing an outline shape of a virtual object on a map. The outline data may be data related to a two-dimensional shape of a virtual object. Alternatively, the outline data may be data related to a three-dimensional shape. A description of the outline data is described above FIGS. 2 and 3, and thus any repetitive detailed explanation will be omitted.

The virtual object storing part 220 may further include attribute values of virtual objects. The attribute of a virtual object means information such as a position value, an address, a shape, a height, a name, a related web page address, an established year of building or sculpture, history of building or sculpture, use of building or sculpture, an age of tree, a kind of tree, etc., storable in a computer-readable storage medium as a database.

In an exemplary embodiment, the virtual object storing part 220 may further store a position value of a point of interest. The point of interest means a position of a specific virtual object capable of inducing an interest of users of map data such as a specific building, a store, etc., besides a simple road or a simple topography displayed on map data. The point of interest is called as an abbreviation “POI.” The point of interest may be set by a service provider providing map data in advance. Alternatively, the point of interest may be set by a user using the map data in addition.

A position value of the point of interest may include a latitude value and a longitude value stored in the map data. The interest point attribute value means information related to the point of interest storable in a computer-readable storage medium as a database, such as names, addresses, shapes and heights of the point of interest, advertisement related to the point of interest, a web page address related to the point of interest, an established year, history, use, kinds, etc., of building or sculpture. The position value of the point of interest and the interest point attribute value correspond with a kind of attribute value of the virtual object.

For example, referring again to FIGS. 3 to 5, the map data 150 includes first to tenth point of interests POI1 to POI10. In FIG. 3, ten points of interest are shown; however, the number of point of interest is not limited thereto.

A first point of interest POI1 includes a position value of the first point of interest POI1 and a first interest point attribute value ATT1. A second point of interest POI2 includes a position value of the second point of interest POI2 and a second interest point attribute value ATT2. Similarly, each of third to tenth points of interest POI3 to POI10 includes position values of the third to tenth points of interest POI3 to POI10 and third to tenth interest point attribute values ATT3 to ATT10, respectively. Each of position values of the first to tenth interest point attribute values ATT1 to ATT10 may include information such as names, addresses, shapes and heights of points of interest POI1 to POI10, trademarks of points of interest POI1 to POI10 and related web page address of points of interest POI1 to POI10, which capable of being stored in a computer-readable storage medium.

The object identifying part 240 divides the map data into a uniform angle gap with respect to an angle section corresponding to an image of the previewed real object with a position previewing a real object as the central figure, and extracts a virtual object from the map data, which has an outline firstly meet with a radiating line corresponding to each map angles of the divided map data.

Particularly, according to an object identification system 200 of the present invention, since a virtual object which has an outline firstly meet with a radiating line corresponding to each map angle of the divided map data from the map data, an attribute value related to a real object not shown on a previewed image is not outputted, and an attribute value shown on the previewed image is only outputted.

A method of extracting a virtual object from the map data, which has an outline firstly meet with a radiating line corresponding to each map angles of the divided map data is described with reference to FIGS. 1 and 2, and thus any repetitive detailed explanation will be omitted.

The object identifying part 240 matches with the virtual object extracted from the map angle and a real object positioned at an azimuth angle substantially equal to a map angle corresponding to the extracted virtual object.

A term “a real object matches with a virtual object” means that the attribute value of a real object and the attribute value of a virtual object are the same as each other or the attribute value of a real object corresponds to or relates to a virtual object having the same attribute value within an error range. For example, a term “a previewed real object (e.g., a real building) matches with a virtual object of map data (i.e., a building on a map)” means that it correspond to the previewed building (i.e., a real object) and a building (i.e., a virtual object) having the same attribute value (e.g., a position or a name) on a map. Namely, it means that the previewed building corresponds to a building on the map in a one-to-one correspondence.

A method of matching a real object positioned at an azimuth angle substantially equal to a map angle corresponding to the extracted virtual object with a virtual object extracted from the map angle is described with reference to FIGS. 1 and 2, and thus any repetitive detailed explanation will be omitted.

When the virtual object storing part 220 stores a position value of point of interest, the object identifying part 240 has to correspond to a point of interest positioned at an area surrounded by an outline of the virtual object and a virtual object having an outline surrounding the point of interest.

For example, referring again to FIGS. 1 to 3, since a position of the first point of interest POI1 is surrounded by an outline of a first virtual object 151, the object identifying part 240 has to correspond to the first point of interest POI1 and the first virtual object 151. In FIG. 3, a virtual object having an outline surrounding a position of a second point of interest POI2 does not exist. Thus, the second point of interest POI2 does not correspond to any virtual object.

Since positions of a third point of interest POI3 and a fourth point of interest POI4 are surrounded by an outline of a second virtual object 152, the object identifying part 240 has to correspond to the third and fourth point of interests POI3 and POI4 and the third virtual object 153. Similarly, the object identifying part 240 has to correspond to the fifth point of interest POI5 and the third virtual object 153, and has to correspond to the seventh point of interest POI7 and the fourth virtual object 154. Moreover, the object identifying part 240 has to correspond to the six and eighth points of interest and the fifth virtual object 155. Moreover, the object identifying part 240 has to correspond to the ninth point of interest POI9 and the seventh virtual object 157, and has to correspond to the tenth point of interest POI10 and the sixth virtual object 156.

When the virtual object storing part 220 stores an attribute value of the point of interest, the object identification system outputs the attribute value of a point of interest positioned at an area surrounded by an outline of the virtual object extracted by the object identifying part 240 to an image of the previewed real object.

For example, the object identifying part 240 extracts a third virtual object 153 matched with the third real object 113 through an object identification method described reference to the FIGS. 1 and 2, and outputs a fifth attribute value ATT5 of a fifth point of interest POI5 positioned at an area surrounded by an outline of the extracted third virtual object 153 to an image of the previewed third real object 113 as shown in FIG. 5. For example, when the fifth attribute value ATT5 of the fifth point of interest POI5 is an advertisement related to the fifth point of interest POI5, an advertisement related to the fifth point of interest POI5 (i.e., an advertisement related to the third real object 113) may be outputted to an image of the previewed third real object 113 in a case of previewing the third real object 113 through the display screen 110 of the mobile terminal 50.

The object identification system may output an attribute value of a virtual object extracted by the object identifying part 240 besides an attribute value of the point of interest to an image of the previewed real object. For example, when it is assumed that a third virtual object 153 has a name called “Kiwiple Building” as an attribute value, the extracted third virtual object 153 is matched with the previewed third real object 113 in the present embodiment. Thus, “Kiwiple Building” that is an attribute value of the third virtual object 153 may be outputted to an image of the previewed third real object 113.

In an exemplary embodiment, when an attribute value of the third virtual object 153 is a web page address, even though the web page address is not inputted through a mobile terminal, it may access to a web page related to the third real object 113 in a state that the third real object 113 matched with the third virtual object 153 is previewed.

In an exemplary embodiment, the virtual object storing part 220 and the object identifying part 240 may be included in a server computer 201. That is, the server computer 201 may handle an information process for identifying an object.

The server computer 201 may wireless communicate with a mobile terminal 50. As an example, the mobile terminal 50 may be a portable telephone, a smart phone, a PDA, a digital video camera, etc.

The mobile terminal 50 may include a display screen 110 displaying an image, an image identifying part 51 identifying an image of a real object, a position measuring part 53 generating a position value of the mobile terminal 50, a direction measuring part 55 generating an azimuth value of a direction previewing a real object, and a data communicating part 59 for communicating with the object identifying part 240.

The image identification part 51 may include, for example, a camera converting a real image into a digital image data. An image identified by the image identification part 51 may be displayed on the display screen 110 in a real time.

The server computer 201 may receive a position value of the mobile terminal 50 from the mobile terminal 260. In this case, the position value of the mobile terminal 50 may correspond to a position RP previewing the real objects shown in FIG. 2 or FIG. 3. The position value of the mobile terminal 50 may be generated by a position measuring part 53 of the mobile terminal 50.

The position measuring part 53 generates a current position value of a mobile terminal 50. For example, the position measuring part 53 may include a global positioning system (GPS) receiver capable of communicating with a GPS satellite. That is, the position measuring part 53 of the mobile terminal 50 may generate a position value of the mobile terminal 50 that is a portion of a real object identification data by using the GPS receiver. Alternatively, the position measuring part 53 may generate a position value of the mobile terminal 50 by measuring a distance between the mobile terminal 50 and a base station such as a wireless local area network access point (WLAN AP) or a distance between the mobile terminal 50 and a repeater.

The direction measuring part 55 generates an azimuth value of a direction previewing a real object through a mobile terminal 50. For example, the direction measuring part 55 may include a terrestrial magnetism sensor grasping a flowing of a magnetic field to detect a direction of a mobile terminal. The terrestrial magnetism sensor detects a variation of current or voltage varied in accordance with a relationship between a magnetic field generated by a sensor and a terrestrial magnetism generated by an earth magnetic field to generate an azimuth value of a direction towards a real object by the mobile terminal 50.

The present invention is not limited to be adapted to a mobile terminal 50 having a direction measuring part 55. For example, an invention related to a method of measuring an azimuth angle of a previewing direction in a mobile terminal which has not a physical direction sensor such as a terrestrial magnetism sensor and an object identification method using the method is disclosed in Korean Patent Application No. 10-2010-0002711.

The object identifying part 240 receives an azimuth value of a direction previewing a real object which is generated by the direction measuring part 55 from the mobile terminal 50, as described reference to FIGS. 1 and 2, and determines an initial azimuth angle IA and an ending azimuth angle EA of an angle section AP corresponding to an image of the previewed real objects from an azimuth angle PA of a previewed position RP and a viewing angle of the display screen 110. As described above, the viewing angle of the display screen 110 may be varied in accordance with a kind of the display screen 110 of a mobile terminal or a scale of the previewed image; however, a viewing angle for the previewed image having a predetermined scale may be set by the mobile terminal 50 previewing the image. A viewing angle of the display screen 110 may be transmitted to an object identification system 200 or a server computer 201 employing an object identification method described reference to FIGS. 1 and 2. That is, the viewing angle of the display screen 110 is not measured to have a predetermined set value in accordance with the display screen 110 and a scale of the previewed image.

Accordingly, the server computer 201 receives a position value of the mobile terminal 50 corresponding to a position previewing the real object and an azimuth value of a direction previewing a real object from the mobile terminal 50, and may correspond a real object previewed through the object identification method described with reference to FIGS. 1 and 2 using the position value of the mobile terminal 50 and the azimuth angle to the extracted virtual object. Moreover, the server computer 201 may transmit an attribute value of a virtual object matched with the previewed real object to the mobile terminal 50. The mobile terminal 50, which receives an attribute value of a virtual object matched with the previewed real object, may output an attribute value of a virtual object matched with the previewed real object to the display screen 110.

FIG. 7 is a block diagram showing an object identification system according to another exemplary embodiment of the present invention.

Referring to FIG. 7, an object identification system 300 according to an exemplary embodiment of the present invention includes a display screen 110 displaying an image, an image identifying part 351 identifying an image of a real object, a position measuring part 353 generating a position value of the object identification system 300, a direction measuring part 355 generating an azimuth value of a direction previewing a real object, a virtual object storing part 360 storing a virtual object and an object identifying part 370 identifying an object. Particularly, in the object identification system 300 according to the present exemplary embodiment, the virtual object storing part 360 and the object identifying part 370 are equipped to a mobile terminal. As an example of the mobile terminal may be a portable digital device such as a portable telephone, a smart phone, a PDA, a digital video camera, etc.

The object identification system 300 of FIG. 7 is substantially the same as the object identification system of FIG. 6 except that the virtual object storing part 360 and the object identifying part 370 are equipped to a mobile terminal, and thus any repetitive detailed explanation will be omitted.

That is, the image identifying part 351, the position measuring part 353 and the direction measuring part 355 of FIG. 7 are substantially the same as the image identifying part 51, the position measuring part 53 and the direction measuring part 55 of FIG. 6, and thus any repetitive detailed explanation will be omitted.

The virtual object storing part 360 stores map data (reference numeral 150 in FIG. 2) including an outline data of a virtual object. Moreover, the virtual object storing part 360 may further store attribute values of virtual objects. The virtual object storing part 360 may further store position values of points of interest. The virtual object storing part 360 is substantially the same as the virtual object storing part 220 of FIG. 6 except that the virtual object storing part 360 is equipped to the mobile terminal, and thus any repetitive detailed explanation will be omitted.

The object identifying part 370 divides the map data into a uniform angle gap with respect to an angle section corresponding to an image of the previewed real object with a position previewing a real object as the central figure, and extracts a virtual object from the map data, which has an outline firstly meet with a radiating line corresponding to each map angles of the divided map data.

A method of extracting a virtual object from the map data, which has an outline firstly meet with a radiating line corresponding to each map angles of the divided map data is described with reference to FIGS. 1 and 2, and thus any repetitive detailed explanation will be omitted.

Moreover, the object identifying part 370 matches with the virtual object extracted from the map angle and a real object positioned at an azimuth angle substantially equal to a map angle corresponding to the extracted virtual object. A method of matching a real object positioned at an azimuth angle substantially equal to a map angle corresponding to the extracted virtual object with a virtual object extracted from the map angle is described with reference to FIGS. 1 and 2, and thus any repetitive detailed explanation will be omitted.

According to the present exemplary embodiment, the virtual object storing part 360 and the object identifying part 370 which are equipped to the mobile terminal 300 itself extract a virtual object having an outline firstly meet with a radiating line corresponding to map angles of each of the divided map data from the map data without the need for transmitting the position value of the mobile terminal 300 and the azimuth angle of the previewing direction to the server computer through a wireless communication, and matches the virtual object extracted from the map angle into a real object positioned at an azimuth angle substantially equal to a map angle corresponding to the extracted virtual object.

Moreover, the mobile terminal 300 may directly output an attribute value of a virtual object matched with the previewed real object to an image of a real object previewed on the display screen 110. An example that an attribute value of a virtual object matched with the previewed real object is outputted to an image of the real object previewed on the display screen 110 is shown in FIG. 5.

Particularly, according to an object identification system 200 of the present invention, since a virtual object which has an outline firstly meet with a radiating line corresponding to each map angle of the divided map data from the map data, an attribute value related to a real object not shown on a previewed image is not outputted, and an attribute value shown on the previewed image is only outputted.

Thus, it may prevent an error of an object identifying and it may identify a real object in a more accurate, thereby improving a quality of an object identification system or an augmented reality service.

The present invention may be used in an object identification system relating to a virtual object of a virtual world and a real object of a real world, a wireless Internet system, an augmented reality service system, an application software program used in the systems, etc. According to the present invention, it may identify a real object in a more accurate, thereby improving a quality of an object identification system or an augmented reality service.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. An object identification system comprising:
a virtual object storing part configured to store map data including an outline data of a virtual object; and
an object identifying part configured to divide map data including outline data of virtual objects with a position previewing real objects as the central figure into a uniform angle gap with respect to an angle section corresponding to an image of the previewed real objects, to extract a virtual object having an outline firstly meet with a radiating line corresponding to each map angles of the divided map data from the map data, and to match with the virtual object extracted from the map angle and a real object positioned at an azimuth angle substantially equal to a map angle corresponding to the extracted virtual object.

2. The object identification system of claim 1, wherein the virtual object storing part further stores a position value of a point of interest, and
the object identifying part matches a point of interest positioned at an area surrounded by an outline of the virtual object with a virtual object having an outline surrounding the point of interest.

3. The object identification system of claim 2, wherein the virtual object storing part further store an attribute value of the point of interest, and
the object identification system outputs the attribute value of a point of interest positioned at an area surrounded by an outline of the virtual object extracted by the object identifying part to an image of the previewed real object.

4. The object identification system of claim 1, wherein the virtual object storing part further store an attribute value of a virtual object, and
the object identification system outputs the attribute value of the virtual object extracted by the object identifying part to an image of the previewed real object.

5. The object identification system of claim 1, wherein the outline data of the map data comprises position values of corners of each of the virtual objects, and an outline of each of the virtual object on the map data is a straight line connecting positions of neighboring corners of each of the virtual objects.

6. The object identification system of claim 1, wherein the virtual object storing part and the object identifying part are equipped to a server computer.

7. The object identification system of claim 6, wherein the virtual object storing part further store an attribute value of a virtual object, and
wherein the server computer receives a position value of the mobile terminal corresponding to a position previewing the real object and an azimuth value of a direction previewing a real object from the mobile terminal, and transmits an attribute value of a virtual object matched with the previewed real object to the mobile terminal.

8. The object identification system of claim 1, wherein the object identification system is a mobile terminal comprising the virtual object storing part and the object identifying part.

9. A method of identifying an object, the method comprising:
dividing map data including outline data of virtual objects with a position previewing real objects as the central figure into a uniform angle gap with respect to an angle section corresponding to an image of the previewed real objects, and extracting a virtual object from the map data, which has an outline firstly meet with a radiating line corresponding to each map angles of the divided map data; and
matching with the virtual object extracted from the map angle and a real object positioned at an azimuth angle substantially equal to a map angle corresponding to the extracted virtual object.

10. The method of claim 9, further comprising:
outputting an attribute value of a virtual object matched with the previewed real object to an image of the previewed real object.

11. The method of claim 9, further comprising:
matching a point of interest positioned at an area surrounded by an outline of a virtual object with a virtual object having an outline surrounding the point of interest.

12. The method of claim 11, wherein an attribute value of a virtual object outputted to an image of the previewed image is an attribute value of a point of interest positioned at an area surrounded by an outline of the extracted virtual object.

13. A computer-readable storage medium storing a software program using an object identification method of claim 9.

14. An object identification system:
configured to divide map data including outline data of virtual objects with a position previewing real objects as the central figure into a uniform angle gap with respect to an angle section corresponding to an image of the previewed real objects,
configured to extract a virtual object having an outline firstly meet with a radiating line corresponding to each map angles of the divided map data from the map data, and
configured to match with the virtual object extracted from the map angle and a real object positioned at an azimuth angle substantially equal to a map angle corresponding to the extracted virtual object.

15. The object identification system of claim 14, wherein an attribute value of a point of interest positioned at an area surrounded by an outline of the virtual object extracted by the object identifying part is outputted to an image of the previewed real object.

16. A server computer identifying a virtual object matched with the previewed real object by using an object identification system of claim 14, and transmitting an attribute value of the identified virtual object to a mobile terminal.

17. A mobile terminal outputting an attribute value of a virtual object matched with the previewed real object by using an object identification system of claim 14.
